(19) United States
(12) Patent Application Publication
(10) Pub. No.: US 2023/0167986 A1
(43) Pub. Date: Jun. 1, 2023

(54) Dehumidifying Apparatus With Dual Dehumidifying Rotor

(71) Applicant: CK Solution Co., Ltd., Gyeonggi-do (KR)

(72) Inventor: Yu Gon Kim, Gyeonggi-do (KR)

(21) Appl. No.: 18/060,803

(22) Filed: Dec. 1, 2022

(30) Foreign Application Priority Data
Dec. 1, 2021 (KR) 10-2021-0170020

(51) Int. Cl. F24F 3/153

(52) U.S. Cl. CPC F24F 3/153; F24F 2003/144

(57) ABSTRACT

A dehumidifying apparatus with dual dehumidifying rotor includes an air supply fan for introducing outside air; a first cooler for cooling the air being introduced through the air supply fan; a first dehumidifying rotor where a dehumidifying area and a regeneration area are formed in a circumferential direction; a second dehumidifying rotor where a dehumidifying area, a purge area and a regeneration area are formed in a circumferential direction; a heater disposed between the second dehumidifying rotor and a dry room that heats air passing each dehumidifying area of the first dehumidifying rotor and the second dehumidifying rotor and being supplied to the dry room; a first regeneration heater that heats air passing the purge area of the second dehumidifying rotor and being returned to the regeneration area; and an exhaust fan that discharges air that passed each regeneration area of the first and second dehumidifying rotors to outside.

### FIELD OF THE INVENTION

The present disclosure relates to a dehumidifying apparatus with dual dehumidifying rotor, and more particularly, to a dehumidifying apparatus with dual dehumidifying rotor, where the dehumidifying rotor is composed in a dual structure so that ultra-low humid air can be provided even at a relatively low regeneration temperature, thereby improving energy use efficiency.

### BACKGROUND OF THE INVENTION

Recently, demand for low-humid environments is increasing in the production processes. A low-humid environment, that is, a dry atmosphere is mainly used as an environment indispensable for manufacturing lithium-related batteries.

In order to increase the quality and yield of products being manufactured in such low-humid environments, a dry room for maintaining a predetermined atmosphere is adopted. In a broad sense, a dry room is a low humid room where the amount of moisture in the air is controlled below a certain value.

Especially, when the dew point temperature of the room is -10° C. or less, it is referred to as a dry room. A dry room is distinguished from low-humid rooms with a relative humidity of 10% to 30%.

Such dry rooms are used not only in lithium-related battery factories, but also in hygroscopic suture manufacturing processes, freeze-dried food companies, automobile environmental laboratories, and other laboratories and factories requiring low-humid conditions.

FIG. 1 is a view for schematically explaining a dehumidifying process of a conventional dehumidifier.

When the dehumidifier starts to operate, a processing fan 12 and a regeneration fan 20 are driven. By the drive of the processing fan 12, outside air is sucked in and transferred to a pre-cooler 10. The pre-cooler 10 performs operations such as removing foreign substances and cooling the air. The pre-cooler 10 removes the moisture contained in the sucked outside air. The air from which moisture has been removed by the pre-cooler 10 is transferred to the processing fan 12. Here, to the processing fan 12, the air passing through a return flow path (also referred to as a return duct) of the dry room (not illustrated) is transferred together.

The air that passed the processing fan 12 is supplied to a dehumidifying treatment area 14a and a purge area 14c of a dehumidifying rotor 14, respectively. The dehumidifying rotor 14 is belt-connected to a motor 16. The air from which moisture has been removed by the dehumidifying treatment area 14a passes an after cooler (not illustrated) and is then supplied to the dry room (not illustrated). In the dry room (not illustrated), humidity is maintained at a set value by the supplied air, and work is performed therein. In the dry room (not illustrated), some of the air is discharged to outside, and the rest of the air is transferred to the processing fan 12 through the return flow path (not illustrated).

Meanwhile, the air supplied to the purge area 14c of the dehumidifying rotor 14 is transferred to a regeneration heater 18 after passing the purge area 14c. The regeneration heater 18 heats the introduced air. The heated air is transferred to a regeneration area 14b of the dehumidifying rotor 14. In the regeneration area 14b, the moisture absorbed in the dehumidifying rotor 14 is taken and removed. The air that passed the regeneration area 14b is discharged to outside by a regeneration fan 20.

However, these conventional dehumidifying apparatuses need to control the regeneration heater to a high temperature in order to provide ultra-low humid air, and the higher the regeneration temperature, the lower the energy use efficiency, resulting in high power consumption, which is a problem.

### Prior Art Literature

### Patent Literature

(Patent Literature 1) Korean Patent Registration No. 10-1064175 (Sep. 15, 2011)

### SUMMARY OF THE INVENTION

Therefore, a purpose of the present disclosure is to solve such problems of prior art, that is, to provide a dehumidifying apparatus with dual dehumidifying rotor, where the dehumidifying rotor is composed in a dual structure so that ultra-low humid air can be provided even at a relatively low regeneration temperature thereby improving energy use efficiency.

Further, another purpose is to provide a dehumidifying apparatus with dual dehumidifying rotor, that rotates each dehumidifying rotor at an optimal rotation speed, thereby improving the dehumidifying efficiency.

The aforementioned purposes are achieved by a dehumidifying apparatus with dual dehumidifying rotor according to the present disclosure, that includes an air supply fan for introducing outside air; a first cooler for cooling the air being introduced through the air supply fan; a first dehumidifying rotor where a dehumidifying area and a regeneration area are formed in a circumferential direction; a second dehumidifying rotor where a dehumidifying area, a purge area and a regeneration area are formed in a circumferential direction; a heater that is disposed between the second dehumidifying rotor and a dry room, and that heats air passing each dehumidifying area of the first dehumidifying rotor and the second dehumidifying rotor and being supplied to the dry room; a first regeneration heater that heats air passing the purge area of the second dehumidifying rotor and being returned to the regeneration area; and an exhaust fan that discharges air that passed each regeneration area of the second dehumidifying rotor and the first dehumidifying rotor, to outside.

Here, it is preferable to further include a first dew point sensor for measuring a dew point of dehumidified air that passed the first dehumidifying rotor; and a first controller that controls a rotation speed of the first dehumidifying rotor based on a measured value of the first dew point sensor.

Further, it is preferable to include a second dew point sensor for measuring a dew point of dehumidified air that passed the second dehumidifying rotor; and a second controller that controls a rotation speed of the second dehumidifying rotor based on a measured value of the second dew point sensor.

Further, it is preferable to include a second dew point sensor for measuring a dew point of dehumidified air that passed the second dehumidifying rotor; and a second controller that controls a rotation speed of the second dehumidifying rotor based on a measured value of the second dew point sensor.

Further, it is preferable to further include a second cooler that is disposed between the first dehumidifying rotor and the second dehumidifying rotor, and that cools the air being supplied from the first dehumidifying rotor to the second dehumidifying rotor.

According to the present disclosure, there is provided a dehumidifying apparatus with dual dehumidifying rotor, where the dehumidifying rotor is composed in a dual structure so that ultra-low humid air can be provided even at a relatively low regeneration temperature thereby improving energy use efficiency.

Further, there is provided a dehumidifying apparatus with dual dehumidifying rotor, that rotates each dehumidifying rotor at an optimal rotation speed, thereby improving dehumidifying efficiency.

### BRIEF DESCRIPTION OF THE DRAWINGS

FIG. 1 is a view for schematically explaining a dehumidifying process of a conventional dehumidifier; and

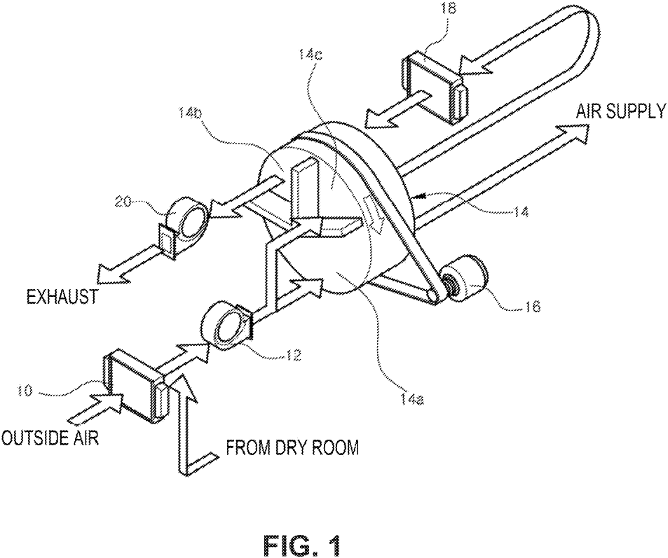

FIG. 2 is a configuration diagram of a dehumidifying apparatus with dual dehumidifying rotor of the present disclosure.

### DETAILED DESCRIPTION OF THE INVENTION

Prior to describing the present disclosure, it is to be noted that in numerous embodiments, a configurative element having the same configuration will be representatively explained in a first embodiment using the same reference numerals, and configurations that are different from the first embodiment will be explained in other embodiments.

Hereinbelow, a dehumidifying apparatus with dual dehumidifying rotor according to a first embodiment of the present disclosure will be described in detail with reference to the attached drawings.

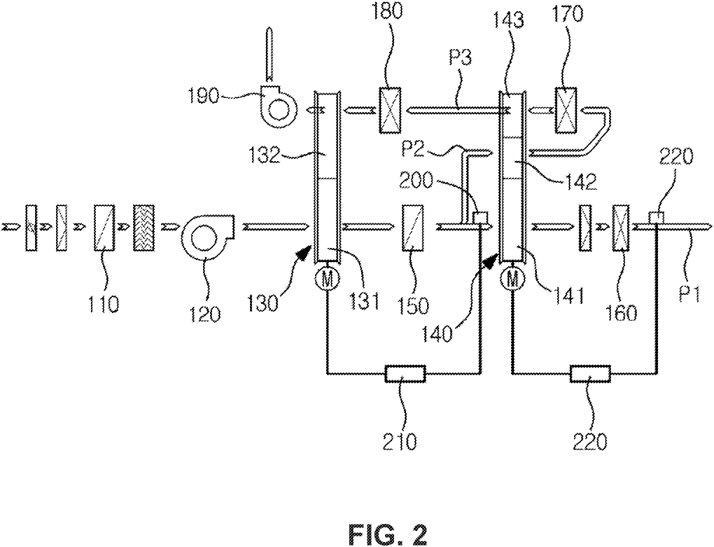

Of the attached drawings, FIG. 2 is a configuration diagram of a dehumidifying apparatus with dual dehumidifying rotor, of the present disclosure.

The dehumidifying apparatus with dual dehumidifying rotor of the present disclosure as disclosed in the aforementioned drawing includes an air supply fan 120, a first cooler 110, a first dehumidifying rotor 130, a second cooler 150, a second dehumidifying rotor 140, a heater 160, a first regeneration heater 170, a second regeneration heater 180, an exhaust fan 190, a first dew point sensor 200, a first controller 210, a second dew point sensor 220, and a second controller 230.

Meanwhile, an air movement path includes the first cooler 110, the air supply fan 120, a dehumidifying area 131 of the first dehumidifying rotor 130, the second cooler 150, a dehumidifying area 141 of the second dehumidifying rotor 140, a first flow path P1 that passes the heater 160 and is connected to a dry room; a second flow path P2 that is branched off from the first flow path 1 located on an upstream side of the second dehumidifying rotor 140 and passes a purge area 142 of the second dehumidifying rotor 140 and connected to the first regeneration heater 170; and a third flow path P3 that is connected to the first regeneration heater 170, a regeneration area 143 of the second dehumidifying rotor 140, the second regeneration heater 180, a regeneration area 132 of the first dehumidifying rotor 130, and the exhaust fan 190.

The air supply fan 120 sucks in outside air and provides a driving force for forming an air flow in the apparatus. The air that passed the air supply fan 120 is supplied to the dehumidifying area 131 of the first dehumidifying rotor 130.

The first cooler 110 is for cooling the air introduced through the air supply fan 120, and may be disposed on an upstream side of the air supply fan 120.

Meanwhile, on an upstream side of the first cooler 110, a damper that is capable of adjusting an amount of air inflow and a filter for removing contaminants in the air may be provided, and on a downstream side of the first cooler 110, a moisture blocker may be provided, for preventing condensed water that has been condensed as the temperature was lowered to a predetermined temperature by the first cooler 110, from being transferred to the air supply fan 120.

The first dehumidifying rotor 130 is formed in a cylindrical shape, and is rotated by a driving motor. The first dehumidifying rotor 130 may be divided into the dehumidifying area 131 disposed on the first flow path P1 and the regeneration area 132 disposed on the third flow path P3, in a circumferential direction based on a central axis. Accordingly, the first dehumidifying rotor 130 may absorb the moisture in the air passing the first flow path P1 in the dehumidifying area 131, and discharge the absorbed moisture to the air passing the third flow path P3 in the regeneration area 132.

The second cooler 150 is disposed on the first flow path P1 between the first dehumidifying rotor 130 and the second dehumidifying rotor 140. The air that passed the dehumidifying area 131 of the first dehumidifying rotor 130 is cooled as it passes the second cooler 150, and is supplied to the dehumidifying area 141 of the second dehumidifying rotor 140.

The second dehumidifying rotor 140 is formed in a cylindrical shape and is rotated by a driving motor. The second dehumidifying rotor 140 may be divided into the dehumidifying area 141 disposed on the first flow path P1, the purge area 142 disposed on the second flow path P2, and the regeneration area 143 disposed on the third flow path P3, in a circumferential direction based on a central axis. Accordingly, the second dehumidifying rotor 140 may absorb the moisture in the air flowing through the first flow path P1 in the dehumidifying area 141, and discharge the absorbed moisture to the air flowing through the third flow path P3 in the regeneration area 143, and is cooled by the air flowing through the second flow path P2 to a temperature suitable for dehumidifying in the purge area 142. That is, the air passing the purge area 142 cools the second dehumidifying rotor 140 heated in the regeneration area 143 to adjust it to a temperature suitable for dehumidifying, and then, as the air passes the regeneration area 143 in a state heated by the first regeneration heater 170, takes away, the air removes the moisture absorbed in the second dehumidifying rotor 140.

The first dehumidifying rotor 130 and the second dehumidifying rotor 140 may each be manufactured by impregnating a solid dehumidifying agent such as a silica gel or zeolite into a wheel having a honeycomb-shaped microstructure or coating on a molded paper similar to a corrugated cardboard, and then rolling it up into a wheel shape.

The heater 160 is disposed on the first flow path P1 between the second dehumidifying rotor 140 and the dry room, and heats the cooled air that has been dehumidified while passing each of the dehumidifying areas 131, 141 of the first dehumidifying rotor 130 and the second dehumidifying rotor 140, to a temperature suitable for the indoor temperature of the dry room.

Meanwhile, on an upstream side of the heater 160, a filter for removing the contaminants in the air, may be provided.

The first regeneration heater 170 is composed to be capable of heating the air that passed the purge area 142 of the second dehumidifying rotor 140 and being returned to the regeneration area 143. The air that is heated by the first regeneration heater 170 removes the moisture absorbed in the second dehumidifying rotor 140 as it passes the regeneration area 143 of the second dehumidifying rotor 140.

The second regeneration heater 180 is disposed on the third flow path P3 between the regeneration area 132 of the first dehumidifying rotor 130 and the regeneration area 143 of the second dehumidifying rotor 140, and is composed to be capable of heating the air passing the regeneration area 143 of the second dehumidifying rotor 140 and being supplied to the regeneration area 132 of the first dehumidifying rotor 130. The air heated by the second regeneration heater 180 removes the moisture absorbed in the first dehumidifying rotor 130 as it passes the regeneration area 132 of the first dehumidifying rotor 130.

It is desirable that the first regeneration heater 170 and the second regeneration heater 180 as described above are composed to be capable of adjusting the regeneration temperature for heating the air as a dehumidifying process variable, and on the third flow path P3, a temperature sensor may each be disposed at a front and back of the first dehumidifying rotor 130 and the second dehumidifying rotor 140, and the regeneration temperature of the first regeneration heater 170 and the second regeneration heater 180 may be set to be adjustable based on the temperature measured in the temperature sensor.

The exhaust fan 190 is configured to be capable of discharging the air containing moisture, that passed each of the regeneration areas 143, 132 of the second dehumidifying rotor 140 and the first dehumidifying rotor 130, to outside, at a distal end of the third flow path P3.

The first dew point sensor 200 measures the dew point of the air that passed the first dehumidifying rotor 130 and transmits the measured dew point to the first controller 210.

The first controller 210 is for controlling the rotation speed of the first dehumidifying rotor 130. The first controller 210 transmits control signals for controlling the rotation speed of the driving motor connected to the first dehumidifying rotor 130 based on the measured value of the first dew point sensor 200.

The second dew point sensor 220 measures the dew point of the dehumidified air that passed the second dehumidifying rotor 140, and transmits the measured dew point to the second controller 230.

The second controller 230 is for controlling the rotation speed of the second dehumidifying rotor 140. The second controller 230 transmits control signals for controlling the rotation speed of the driving motor connected to the second dehumidifying rotor 140 based on the measured value of the second dew point sensor 220.

Here, the first controller 210 and the second controller 230 may control the rotation speed of the first dehumidifying rotor 130 and the second dehumidifying rotor 140 initially to be between 4rph and 25 rph, and then control it to an optimal rotation speed for maintaining the predetermined dew point temperature depending on the dew point temperature measured in the first dew point sensor 200 and the second dew point sensor 220.

From now, operations of a first embodiment of the aforementioned dehumidifying apparatus with dual dehumidifying rotor will be described.

The air introduced into the apparatus by the air supply fan 120 is cooled to a predetermined temperature as it passes the first cooler 110, and is then provided to the first flow path P1.

The air provided to the first flow path P1 is primarily dehumidified as it passes the dehumidifying area 131 of the first dehumidifying rotor 130, and is additionally cooled to a predetermined temperature as it passes the second cooler 150, and is then secondarily dehumidified as it passes the dehumidifying area 141 of the second dehumidifying rotor 140, and is provided to the dry room in a state where it is heated to a predetermined temperature in the heater 160.

Further, the air provided to the second flow path P2 branched from the first flow path P1 located between the second cooler 150 and the second dehumidifying rotor 140 cools the second dehumidifying rotor 140 heated in the regeneration area 143 as the air passes the purge area 142 of the second dehumidifying rotor 140, and then the air is provided to the first regeneration heater 170.

In addition, the air provided to the third flow path P3 in a state where it is heated in the first regeneration heater 170 dries the second dehumidifying rotor 140 as it passes the regeneration area 143 of the second dehumidifying rotor 140, and is reheated by the second regeneration heater 180, and dries the first dehumidifying rotor 130 as it passes the regeneration area 132 of the first dehumidifying rotor 130, and is then discharged to outside through the exhaust fan 190.

Meanwhile, the first controller 210 may be disposed on a downstream side of the second cooler 150, to determine the rotation speed of the first dehumidifying rotor 130 based on the measured value of the first dew point sensor 200 that measures the dew point temperature of the air passing the first flow path P1. Likewise, the second controller 230 may be disposed on a downstream side of the heater 160, to determine the rotation speed of the second dehumidifying rotor 140 based on the measured value of the second dew point sensor 220 that measures the dew point temperature of the air passing the first flow part P1.

That is, the rotation speed of the first dehumidifying rotor 130 and the second dehumidifying rotor 140 are controlled by the dew point temperature of the air, and since the dew point temperature is determined according to the regeneration efficiency in the regeneration area, consequently, by controlling the rotation speed of the dehumidifying rotor in response to the regeneration efficiency, it is possible to maximize the dehumidifying efficiency of the apparatus.

In general, the dehumidifying performance of the dehumidifying apparatus largely depends on the regeneration temperature. That is, the higher the regeneration temperature, the smoother the regeneration, and thus by increasing the rotation speed of the dehumidifying rotor, the dehumidifying amount can be increased. Therefore, by controlling the rotation speed of the dehumidifying rotor according to the regeneration efficiency, the dehumidifying performance of the dehumidifying apparatus can be further improved.

According to the present embodiment described above, by composing the dehumidifying rotor in a dual structure of the first dehumidifying rotor 130 and the second dehumidifying rotor 140, the first regeneration heater 170 and the second regeneration heater 180 can be controlled within the regeneration temperature corresponding to the general dehumidifying condition (about 140 degrees) while providing ultra-low humid air (dew point temperature of -70 degrees or below), and thus energy efficiency can be improved.

Further, by measuring the dew point temperature of the air through the first dew point sensor 200 and the second dew point sensor 220, and through that, by controlling the rotation speed of each of the first dehumidifying rotor 130 and the second dehumidifying rotor 140, it is possible to maintain the optimal rotation speed according to the regeneration processing efficiency in the regeneration area, thereby maximizing the dehumidifying efficiency. Accordingly, it is possible to not only improve the energy efficiency but also provide a relatively large volume of air compared to existing dehumidifying apparatuses, and therefore, it is possible to reduce the size of the dehumidifying apparatus.

The scope of right of the present disclosure is not limited to the aforementioned embodiments, but may be implemented in various forms of embodiments within the scope of the following claims set. It should be understood that various changes and alternations can be made without departing from the spirit and field of the present disclosure claimed in the claims set.

### Reference Numerals

110: FIRST COOLER, 120: AIR SUPPLY FAN, 130: FIRST DEHUMIDIFYING ROTOR, 140: SECOND DEHUMIDIFYING ROTOR, 150: SECOND COOLER, 160: HEATER, 170: FIRST REGENERATION HEATER, 180: SECOND REGENERATION HEATER, 190: EXHAUST FAN, 200: FIRST DEW POINT SENSOR, 210: FIRST CONTROLLER, 220: SECOND DEW POINT SENSOR, 230: SECOND CONTROLLER, P1: FIRST FLOW PATH, P2, SECOND FLOW PATH, P3: THIRD FLOW PATH

What is claimed is:

1. A dehumidifying apparatus with dual dehumidifying rotor, comprising:
an air supply fan for introducing outside air;
a first cooler for cooling the air being introduced through the air supply fan;
a first dehumidifying rotor where a dehumidifying area and a regeneration area are formed in a circumferential direction;
a second dehumidifying rotor where a dehumidifying area, a purge area and a regeneration area are formed in a circumferential direction;
a heater that is disposed between the second dehumidifying rotor and a dry room, and that heats air passing each dehumidifying area of the first dehumidifying rotor and the second dehumidifying rotor and being supplied to the dry room;
a first regeneration heater that heats air passing the purge area of the second dehumidifying rotor and being returned to the regeneration area; and
an exhaust fan that discharges air that passed each regeneration area of the second dehumidifying rotor and the first dehumidifying rotor, to outside.

2. The dehumidifying apparatus with dual dehumidifying rotor, according to claim 1,
further comprising a first dew point sensor for measuring a dew point of dehumidified air that passed the first dehumidifying rotor; and
a first controller that controls a rotation speed of the first dehumidifying rotor based on a measured value of the first dew point sensor.

3. The dehumidifying apparatus with dual dehumidifying rotor, according to claim 2,
comprising a second dew point sensor for measuring a dew point of dehumidified air that passed the second dehumidifying rotor; and
a second controller that controls a rotation speed of the second dehumidifying rotor based on a measured value of the second dew point sensor.

4. The dehumidifying apparatus with dual dehumidifying rotor, according to claim 1,
further comprising a second regeneration heater that is disposed between the first dehumidifying rotor and the second dehumidifying rotor, and that heats the air being supplied from the second dehumidifying rotor to the first dehumidifying rotor.

5. The dehumidifying apparatus with dual dehumidifying rotor, according to claim 1,
further comprising a second cooler that is disposed between the first dehumidifying rotor and the second dehumidifying rotor, and that cools the air being supplied from the first dehumidifying rotor to the second dehumidifying rotor.
